(19) United States
(12) Patent Application Publication
(10) Pub. No.: US 2003/0132625 A1
(43) Pub. Date: Jul. 17, 2003

(54) Closed cylinder tilt module

(76) Inventors: Travis D. Bechtel, Goodrich, MI (US); William J. Elliott, Commerce, MI (US)

Correspondence Address: Ralph E. Smith, DaimlerChrysler Intellectual Capital Corporation, CIMS 483-02-19, 800 Chrysler Drive, Auburn Hills, MI, 48326-2757, US

(21) Appl. No.: 10/047,224

(22) Filed: Jan. 14, 2002

(51) Int. Cl. B62D 1/18

(52) U.S. Cl. 280/775

(57) ABSTRACT

A tilt mechanism for adjusting an angular position of an automotive steering column. The tilt mechanism includes an adjustment cylinder assembly having a fluid power cylinder, a fluid conduit and a valve. The adjustment cylinder assembly is configured in a closed-loop manner such that the fluid that is displaced from one side of the cylinder is directed to the other side of the cylinder. The valve is employed to inhibit the flow of fluid between the sides of the cylinder to thereby lock the tilt mechanism in a desired position.

### FIELD OF THE INVENTION

The present invention generally relates to vehicle steering systems and more particularly to a tilt mechanism for adjusting the position of a vehicle steering column.

### BACKGROUND OF THE INVENTION

Known tilt mechanisms for adjusting the angular position of a vehicle steering column typically employ rather complex linkage mechanisms for locking the steering column in a desired angular position. These linkage systems are typically limited to a relatively low number of discrete adjustment positions.

Accordingly, there remains a need in the art for a tilt mechanism for adjusting the angular position of a vehicle steering column that is robust yet relatively simple in design and which provides a larger degree of adjustment.

### SUMMARY OF THE INVENTION

In one preferred form, the present invention provides a tilt mechanism for adjusting an angular position of an automotive steering column. The tilt mechanism includes a first structure that is adapted to be fixedly coupled to a vehicle frame, a second structure that is adapted to support the steering column and which is pivotably coupled to the first structure, and an adjustment cylinder assembly. The adjustment cylinder assembly includes a cylinder, a fluid conduit and a valve. The cylinder has a housing with a central bore, a piston slidingly disposed in the central bore and a rod that is fixedly coupled to the piston. The piston segregates the housing into a first cavity and a second cavity. The housing is pivotably coupled to one of the first and second structures. An end of the rod is pivotably coupled to the other one of the first and second structures. The fluid conduit operably couples the first and second cavities for fluid communication therebetween. The valve is coupled to the fluid conduit and is operable in a first condition, which permits fluid communication between the first and second cavities through the fluid conduit, and a second condition, which restricts fluid communication between the first and second cavities by inhibiting the flow of a working fluid through the fluid conduit.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

Additional advantages and features of the present invention will become apparent from the subsequent description and the appended claims, taken in conjunction with the accompanying drawings, wherein:

FIG. 1 is a fragmentary side elevational view of a portion of a vehicle with parts being broken away to show a tilt mechanism constructed in accordance with the teachings of the present invention;

FIG. 2 is a side elevational view of the tilt mechanism of FIG. 1; and

FIG. 3 is a schematic view of a portion of the tilt mechanism of FIG. 1 illustrating the fluid circuitry in greater detail.

### DETAILED DESCRIPTION OF THE PREFERRED EMBODIMENTS

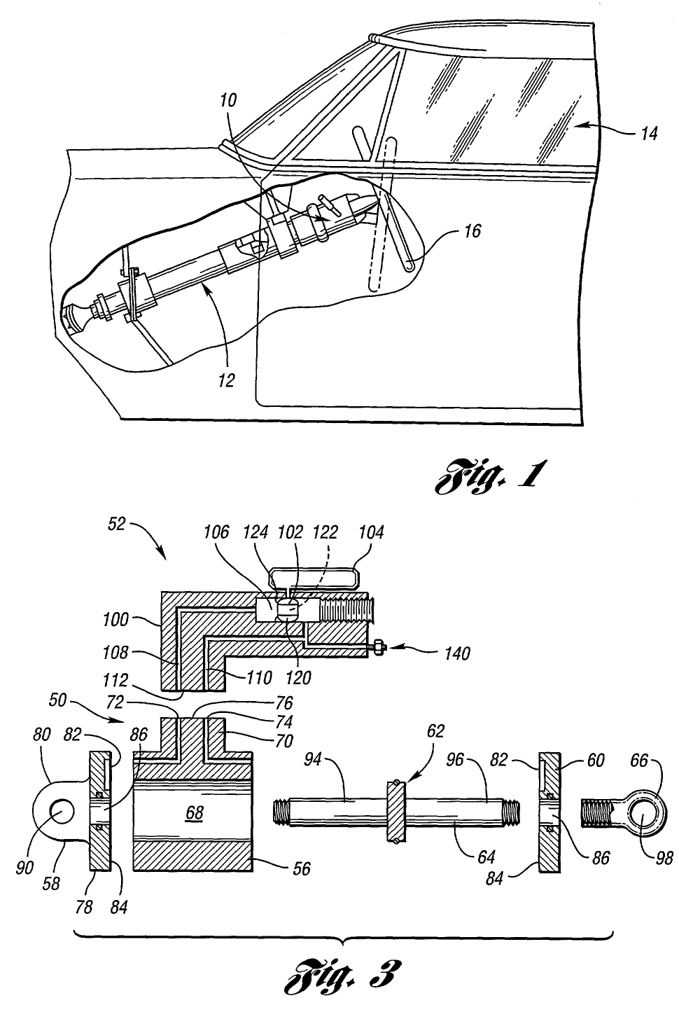

With reference to FIG. 1 of the drawings, a tilt mechanism constructed in accordance with the teachings of the present invention is generally indicated by reference numeral 10. The tilt mechanism 10 is illustrated in operative association with a steering column 12. The steering column 12 extends upwardly and rearwardly into the vehicle passenger compartment 14 and conventionally includes a suitable coupler (not shown) of known construction, which is coupled to a steering gear assembly for steering the wheels of a vehicle. A steering wheel 16, which is configured to receive a steering input from a vehicle operator, is affixed to the opposite end of the steering column 12.

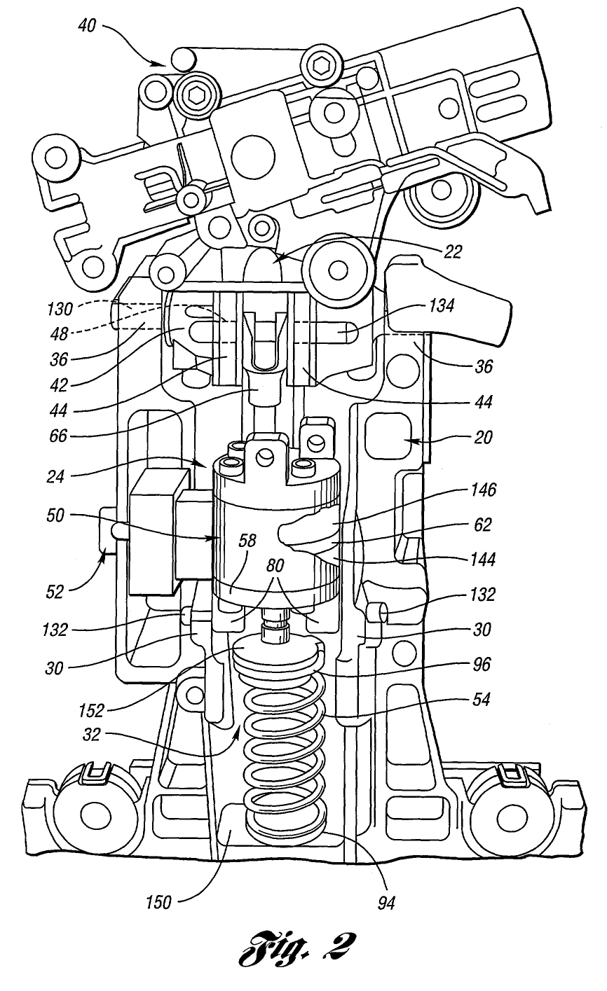

With additional reference to FIG. 2, the tilt mechanism 10 is illustrated to include a fixed yoke 20, a pivoting yoke 22 and an adjustment cylinder assembly 24. The fixed yoke 20 is configured to be affixed to the vehicle frame (not shown) and includes a pair of first mounting trunnions 30 and a second mounting trunnion 36. The first mounting trunnions 30 are spaced apart from one another and cooperate to define a channel 32 therebetween. A first pin aperture is formed through the first mounting trunnions 30. The second mounting trunnion 36 is spaced apart upwardly from the first mounting trunnions 30 and includes a second pin aperture (not specifically shown) formed therethrough along an axis that is generally parallel that of the first pin aperture.

The pivoting yoke 22 includes a sleeve portion 40, a third mounting trunnion 42 and a pair of fourth mounting trunnions 44. The sleeve portion 40 includes an aperture (not specifically shown) that is sized to receive and rotatably support the steering column 12 proximate the steering wheel 16. The third mounting trunnion 42 extends from the sleeve portion 40. A third pin aperture (not specifically shown) is formed through the third mounting trunnion 42. The fourth mounting trunnions 44 are spaced apart from one another, extending from the sleeve portion 40. A fourth pin aperture 48 is formed through the fourth mounting trunnions 44 along an axis that is generally parallel that of the third pin aperture.

The adjustment cylinder assembly 24 is illustrated to include a cylinder assembly 50, a valve assembly 52 and a spring 54. With additional reference to FIG. 3, the cylinder assembly 50 includes a housing 56, first and second end caps 58 and 60, respectively, a piston 62, a rod 64 and a rod yoke 66. The housing 56 is illustrated to be generally shaped as a hollow cylinder having a central bore 68, a coupling pad 70 protruding from its midsection. A pair of fluid conduits 72 and 74 are formed into the housing 56, each extending in a generally L-shaped manner from an end of the housing 56 to the face 76 of the coupling pad 70.

The first end cap 58 includes a cylindrical body 78 and a pair of end cap trunnions 80. A fluid entry port 82 is formed into a first side 84 of the body 78, while a rod aperture 86 is formed through the body 78. The end cap trunnions 80 extend from a second side 88 of the body 78 and a fifth pin aperture 90 is formed through the end cap trunnions 80.

The second end cap 60 is constructed in a manner that is nearly identical to that of the first end cap 58, except that the second end cap 60 does not include any end cap trunnions. The first and second end caps 58 and 60 are aligned to the housing 56 such that the fluid entry ports 82 of the first and second end caps 58 and 60 are aligned to the fluid conduits 72 and 74, respectively, and fixedly secured to the opposite ends of the housing 56 to substantially close off the central bore 68.

The piston 62, rod 64 and rod yoke 66 are conventional in their construction and need not be discussed in significant detail. Briefly, the piston 62 is sized to slidingly and sealingly engage the central bore 68 of the housing 56. The rod 64 is coupled to the piston 62 such that the first and second ends 94 and 96, respectively, extend from the opposite faces of the piston 62 and out of the rod apertures 86 in the first and second end caps 58 and 60, respectively. A seal is disposed in each rod aperture 86 to seal against both the rod 64 and the housing 56. The rod yoke 66 is fixedly coupled (via threaded engagement) to the second end 96 of the rod 64 and includes a sixth pin aperture 98.

The valve assembly 52 includes a valve body 100, a valve element 102 and an actuator, such as a handle 104. The valve body 100 includes a valve element aperture 106 that is configured to house the valve element 102. In the particular embodiment illustrated, the valve body 100 also includes a pair of fluid conduits 108 and 110 that extending from a mounting flange 112 to the valve element aperture 106. The mounting flange 112 is configured to mate to the coupling pad 70 such that the first and third fluid conduits 72 and 108 are in fluid connection with one another and the second and fourth fluid conduits 74 and 110 are in fluid connection with one another. In the example provided, seals (not shown) are disposed between the valve body 100 and the housing 56 and threaded fasteners (not shown) are employed to fixedly couple the valve body 100 to the housing 56.

The valve element 102 is disposed in the valve element aperture 106 and is movable between a first position, which permits fluid communication between the third and fourth fluid conduits 108 and 110, and a second position, which inhibits fluid communication between the third and fourth fluid conduits 108 and 110. In the particular embodiment illustrated, the valve element 102 is shown to be a spherical ball 120, having a hole 122 formed therethrough and a seal member 124, which is engaged to both the ball 120 and the sides of the valve element aperture 106. The ball 120 is coupled for rotation with the handle 104 and thus operates much in the same manner as a conventional ball valve. When positioned in the first position, the hole 122 is rotated into alignment with the third and fourth fluid conduits 108 and 110 to permit fluid to flow through the ball 120. When positioned in the second position, the hole 122 is rotated out of alignment with the third and fourth conduits 108 and 110 to inhibit the flow of fluid between the third and fourth conduits 108 and 110.

A first pivot pin 130, which extends through the second pin aperture in the second mounting trunnion 36 and the third pin aperture in the third mounting trunnion 42, pivotably couples the fixed yoke 20 and the pivoting yoke 22 to one another. A pair of second pivot pins 132 are employed to pivotably couple the first end cap 58 to the fixed yoke 20. More specifically, each of the second pivot pins 132 extends through the first pin aperture in one of the first mounting trunnions 30 and one of the fifth pin apertures 90 in an associated one of the end cap trunnions 80. A third pivot pin 134 is employed to pivotably couple the rod yoke 66 and the pivoting yoke 22. More specifically, pivoting yoke 22 is positioned between the pair of fourth mounting trunnions 44 and the third pivot pin 134 is disposed through the fourth pin apertures 48 in the fourth mounting trunnions 44 and the sixth pin aperture 98 in the pivoting yoke 22.

A working fluid, such as a liquid or a compressed gas, is introduced into the cylinder assembly 50 and the valve assembly 52. The working fluid is preferably an incompressible fluid, such as a light oil. An air bleed valve 140, which is coupled to the valve body 100, is in fluid communication with the third and fourth fluid conduits 108 and 110 and is employed to purge air from the cylinder assembly 50 and valve assembly 52. The piston 62 segregates the central bore 68 into first and second cavities 144 and 146, respectively. When the ball 120 is positioned in the first position, fluid may freely circulate between the first and second cavities 144 and 146 via the first, third, fourth and second fluid conduits 72, 108, 110 and 74. Accordingly, the piston 62 may freely travel within the central bore 68 to thereby increase or reduce the amount by which the second end 96 of the rod 64 extends from the second end cap 60. When the ball 120 is positioned in the second position, fluid cannot flow between the third and fourth fluid conduits 108 and 110 and fluid communication between the first and second cavities 144 and 146 is prevented. As such, the piston 62 and rod 64 are immovable relative to the housing 56 when the ball 120 is positioned in the second position and thereby fix the pivoting yoke 22 in a particular orientation since the amount by which the second end 96 of the rod 64 extends from the second end cap 60 is fixed. Those skilled in the art will understand that the degree to which the pivoting yoke 22 is locked in a particular orientation will depend upon the integrity of the closed-loop fluid circuit and the particular type of working fluid that is used. With regard to the latter issue, if the working fluid is a compressible fluid, such as nitrogen or air, the application of sufficient force onto the pivoting yoke 22 would cause the pivoting yoke 22 to move as the force exerted through the piston 62 would compress the fluid in one of the first and second cavities 144 and 146.

The spring 54 is disposed within the channel 32 between the first mounting trunnions 30 such that a first end 94 abuts a tab 150 that is formed on the fixed yoke 20 and the second end 96 abuts plunger 152 that is coupled to the first end 94 of the rod 64. The spring 54 operably biases the rod 64 toward the housing 56 of the cylinder assembly 50 to thereby bias the pivoting yoke 22 upwardly.

While the invention has been described in the specification and illustrated in the drawings with reference to a preferred embodiment, it will be understood by those skilled in the art that various changes may be made and equivalents may be substituted for elements thereof without departing from the scope of the invention as defined in the claims. In addition, many modifications may be made to adapt a particular situation or material to the teachings of the invention without departing from the essential scope thereof. Therefore, it is intended that the invention not be limited to the particular embodiment illustrated by the drawings and described in the specification as the best mode presently contemplated for carrying out this invention, but that the invention will include any embodiments falling within the foregoing description and the appended claims.

What is claimed is:

1. A tilt mechanism for adjusting an angular position of an automotive steering column, the tilt mechanism comprising:
a first structure that is adapted to be fixedly coupled to a vehicle frame;
a second structure that is adapted to support the steering column, the second structure being pivotably coupled to the first structure; and
an adjustment cylinder assembly having a cylinder, a fluid conduit and a valve, the cylinder having a housing with a central bore, a piston slidingly disposed in the central bore and a rod that is fixedly coupled to the piston, the piston segregating the housing into a first cavity and a second cavity, the housing being pivotably coupled to one of the first and second structures, an end of the rod being pivotably coupled to the other one of the first and second structures, the fluid conduit operably coupling the first and second cavities for fluid communication therebetween, the valve being coupled to the fluid conduit and being operable in a first condition, which permits fluid communication between the first and second cavities through the fluid conduit, and a second condition, which restricts fluid communication between the first and second cavities by inhibiting the flow of a working fluid through the fluid conduit.

2. The tilt mechanism of claim 1, wherein the working fluid is an incompressible fluid.

3. The tilt mechanism of claim 2, wherein the incompressible fluid is oil.

4. The tilt mechanism of claim 1, wherein the rod extends though the opposite ends of the housing.

5. The tilt mechanism of claim 4, further comprising a plunger and a spring, the plunger being coupled to a second end of the rod, the second end of the rod being opposite the other one of the first and second structures, the spring being disposed between the plunger and the one of the first and second structures and biasing the second end of the rod toward the housing of the cylinder.

6. The tilt mechanism of claim 1, wherein the valve includes a valve body and a valve element, the valve body being in fluid communication with the fluid conduit, the valve element being movably disposed in the valve body.

7. The tilt mechanism of claim 6, wherein the valve element is a ball having a hole formed therethrough.

8. The tilt mechanism of claim 1, wherein the adjustment cylinder assembly further includes an air bleed valve in fluid communication with the first and second cavities.

9. A tilt mechanism for adjusting an angular position of an automotive steering column, the tilt mechanism comprising:
a first structure that is adapted to be fixedly coupled to a vehicle frame;
a second structure that is adapted to support the steering column, the second structure being pivotably coupled to the first structure; and
an adjustment cylinder assembly having a cylinder, a fluid conduit and a valve, the cylinder having a housing with a central bore, a piston slidingly disposed in the central bore and a rod that is fixedly coupled to the piston, the piston segregating the housing into a first cavity and a second cavity, the housing being pivotably coupled to one of the first and second structures, a first end of the rod being pivotably coupled to the other one of the first and second structures, the fluid conduit operably coupling the first and second cavities for fluid communication therebetween, the valve being coupled to the fluid conduit and being operable in a first condition and a second condition, the cylinder, the fluid conduit and the valve being filled with an incompressible working fluid, the working fluid moving through the fluid conduit in response to movement of the piston in the central bore when the valve is in the first condition, the working fluid inhibiting movement of the piston in the central bore when the valve is in the second condition.

10. The tilt mechanism of claim 9, wherein the rod extends though the opposite ends of the housing.

11. The tilt mechanism of claim 10, further comprising a plunger and a spring, the plunger being coupled to a second end of the rod, the second end of the rod being opposite the other one of the first and second structures, the spring being disposed between the plunger and the one of the first and second structures and biasing the second end of the rod toward the housing of the cylinder.

12. The tilt mechanism of claim 9, wherein the valve includes a valve body and a valve element, the valve body being in fluid communication with the fluid conduit, the valve element being movably disposed in the valve body.

13. The tilt mechanism of claim 12, wherein the valve element is a ball having a hole formed therethrough.

14. The tilt mechanism of claim 9, wherein the adjustment cylinder assembly further includes an air bleed valve in fluid communication with the first and second cavities.

15. A tilt mechanism for adjusting an angular position of an automotive steering column, the tilt mechanism comprising:
a first structure that is adapted to be fixedly coupled to a vehicle frame;
a second structure that is adapted to support the steering column, the second structure being pivotably coupled to the first structure; and
an adjustment cylinder assembly having a double-ended cylinder, a fluid conduit, a valve, a plunger and a spring, the cylinder having a housing with a central bore, a piston slidingly disposed in the central bore and a rod that is fixedly coupled to the piston, the piston segregating the housing into a first cavity and a second cavity, the housing being pivotably coupled to one of the first and second structures, a first end of the rod being pivotably coupled to the other one of the first and second structures, a second end of the rod being coupled to the plunger, the fluid conduit operably coupling the first and second cavities for fluid communication therebetween, the valve being coupled to the fluid conduit and being operable in a first condition and a second condition, the double-ended cylinder, the fluid conduit and the valve being filled with an incompressible working fluid, the working fluid moving through the fluid conduit in response to movement of the piston in the central bore when the valve is in the first condition, the working fluid inhibiting movement of the piston in the central bore when the valve is in the second condition, the spring being disposed between the plunger and the one of the first and second structures and biasing the second end of the rod toward the housing of the cylinder.
